(19) United States
(12) Patent Application Publication
(10) Pub. No.: US 2015/0326757 A1
(43) Pub. Date: Nov. 12, 2015

(54) HOUSING ASSEMBLY

(71) Applicant: Yu-Lin HUANG, New Taipei City (TW)

(72) Inventor: Yu-Lin HUANG, New Taipei City (TW)

(21) Appl. No.: 14/274,765

(22) Filed: May 11, 2014

(51) Int. Cl. H04N 5/225; H04N 7/18

(52) U.S. Cl. CPC H04N 5/2252; H04N 7/183

(57) ABSTRACT

A housing assembly for a monitoring system is provided. The housing assembly includes a main housing, a light transmission member, an adjustable arm and a shield. The main housing has a front face. The main housing has an opening located on the front face. The monitoring system is located in the main housing. The light transmission member is assembled with the opening, in which the monitoring system monitors via the light transmission member.

The adjustable arm is connected to the main housing and a fixed object outside the main housing for adjusting an orientation of the main housing relative to the fixed object. The shield is slidably connected to the main housing and capable of sliding to extend outwards from the front face.

### BACKGROUND

1. Technical Field

The present disclosure relates to a housing assembly. More particularly, the present disclosure relates to a housing assembly for a monitoring system.

2. Description of Related Art

In recent years, video surveillance has been widely used in various public facilities like roads, homes, shopping malls, factories and hospitals as an important mechanism for deterring crime and safety protection. Due to the wide range of application requirements of monitoring systems, a particular protective cover is usually designed for the corresponding monitoring system in order to prevent any unwanted light from getting into the photosensitive element of the monitoring system. This protective cover can also prevent unwanted substances like rainwater and dust from sticking on the light transmission member and blocking the view of the scene the monitoring system is capturing.

At present, there are two modes of protective cover. One is directly formed as a single piece with the housing of monitoring system. However, this reduces the flexibility for the change of the shape and size of the housing together with the protective cover. The other one is to add rigidly a protective cover to an existing housing of a monitoring system, so as to increase the flexibility of the design. However, for both modes, the position of the protective cover relative to the housing cannot be flexibly adjusted according to the actual conditions of the location where the monitoring system is installed.

### SUMMARY

A technical aspect of the present disclosure provides a housing assembly for a monitoring system, of which a shield can be flexibly adjusted to prevent any unwanted light from entering into the monitoring system and unwanted substances like rainwater and dust from sticking on the light transmission member and blocking the view of the scene the monitoring system is capturing.

According to an embodiment of the present disclosure, a housing assembly for a monitoring system is provided. The housing assembly includes a main housing, a light transmission member, an adjustable arm and a shield. The main housing has a front face. The main housing has an opening located on the front face. The monitoring system is located in the main housing. The light transmission member is assembled with the opening, in which the monitoring system monitors via the light transmission member. The adjustable arm is connected to the main housing and a fixed object outside the main housing for adjusting an orientation of the main housing relative to the fixed object. The shield is slidably connected to the main housing and capable of sliding to extend outwards from the front face.

In one or more embodiments of the present disclosure, the light transmission member is transparent.

In one or more embodiments of the present disclosure, the main housing has a first surface, the shield has a second surface facing the first surface. A profile along the first surface fits a profile along the second surface in shape.

In one or more embodiments of the present disclosure, the main housing includes a first guiding structure disposed at an edge of the first surface, the shield includes a second guiding structure disposed at an edge of the second surface, the first guiding structure is slidably engaged to the second guiding structure such that sliding of the shield relative to the main housing is guided.

In one or more embodiments of the present disclosure, the shield is located on top of the main housing relative to a horizontal reference plane.

In one or more embodiments of the present disclosure, the housing assembly further includes a sealing piece. The sealing piece is disposed between the main housing and the shield.

In one or more embodiments of the present disclosure, the sealing piece is made of waterproof sealing material.

In one or more embodiments of the present disclosure, the main housing includes a locking member. The locking member is configured for locking the shield to the main housing to selectively fix the position of the shield relative to the main housing.

In one or more embodiments of the present disclosure, the main housing has a through hole. The shield has a slot communicated with the through hole. The locking member includes a bolt and a nut. The bolt passes through the slot and the through hole and is fastened into the nut.

In one or more embodiments of the present disclosure, the locking member is a clamp.

In one or more embodiments of the present disclosure, the housing assembly further includes a guiding groove. The guiding groove is disposed on at least part of an edge of a surface of the shield opposite to the main housing.

When compared with the prior art, the embodiments of the present disclosure mentioned above have at least the following advantages:

(1) In the embodiments of the present disclosure, a shield is slidably connected to the main housing and capable of sliding to extend outwards from the front face. That means the extension of the shield from the front face can be adjusted according to different outdoor conditions. Thus, the shield can effectively prevent any unwanted light from entering into the monitoring system and unwanted substances like rainwater and dust from sticking on the light transmission member and blocking the view of the scene the monitoring system is capturing.

(2) In the embodiments of the present disclosure, a profile along the first surface of the main housing fits in shape with a profile along the second surface of the shield. Therefore, there is no seam between the main housing and the shield. When rainwater falls on the top of the main housing, it cannot flow through between the main housing and the shield. Thus, the rainwater falling on the top of the main housing cannot reach the front face of the main housing and block the view of the scene the monitoring system is capturing.

(3) Since the position of the shield relative to the main housing is fixed simply by a locking member locking the shield to the main housing, the operation is simple and easy especially in outdoor conditions.

### BRIEF DESCRIPTION OF THE DRAWINGS

The disclosure can be more fully understood by reading the following detailed description of the embodiments, with reference made to the accompanying drawings as follows:

FIG. 1 is a side view of a housing assembly according to an embodiment of the present disclosure;

FIG. 2 is a sectional view of the hosing assembly of FIG. 1 along the section line A-A; and

FIG. 3 is a sectional view of the housing assembly according to another embodiment of the present disclosure along the section line A-A of FIG. 1.

### DETAILED DESCRIPTION

Drawings will be used below to disclose a plurality of embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

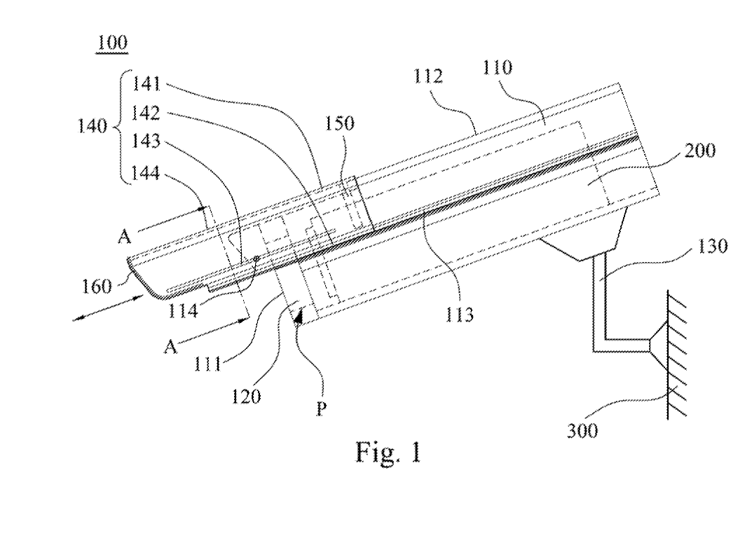

FIG. 1 is a side view of a housing assembly 100 according to an embodiment of the present disclosure. As shown in FIG. 1, a housing assembly 100 for a monitoring system 200 is provided. The housing assembly 100 includes a main housing 110, a light transmission member 120, an adjustable arm 130, and a shield 140. The main housing 110 has a front face 111. The main housing 110 has an opening P located on the front face 111. The monitoring system 200 is located in the main housing 110. The light transmission member 120 is assembled with the opening P, in which the monitoring system 200 monitors via the light transmission member 120. The adjustable arm 130 is connected to the main housing 110 and a fixed object 300 outside the main housing 110 for adjusting an orientation of the main housing 110 relative to the fixed object 300. The shield 140 is slidably connected to the main housing 110 and capable of sliding to extend outwards from the front face 111.

In general, the front face 111 of the main housing 110 is facing the scene under surveillance. That means the light transmission member 120 is also facing the scene under surveillance. During the operation of the monitoring system 200, the light from the scene passes through the light transmission member 120 and gets into the photosensitive element (not shown in FIG. 1) of the monitoring system 200, such that the view of the scene is captured by the monitoring system 200. However, when the sunlight is too strong or there exists some other unwanted light sources, excessive sunlight or lights from the unwanted light sources may enter into the photosensitive element as well through the light transmission member 120. Consequently, the original light from the scene under surveillance will become relatively unclear, thus affecting the quality of the view captured by the monitoring system 200. In this case, the position of the shield 140 relative to the main housing 110 can be adjusted such that the unwanted lights can be substantially blocked and prevented from entering into the photosensitive element of the monitoring system 200. Hence, the quality of the view aptured by the monitoring system 200 is maintained.

Typically, the shield 140 is located on top of the main housing 110 relative to a horizontal reference plane. As a result, apart from blocking excessive sunlight, the shield 140 can also effectively prevent unwanted substances like rainwater and dust from sticking on the light transmission member 120 and blocking the view of the scene the monitoring system 200 is capturing.

The light transmission member 120 is transparent to visible light, or invisible light if required. In this embodiment, the light transmission member 120 can be made of glass. It is noted that the material of the light transmission member 120 as cited herein is only illustrative and is not to limit the claimed scope. A person having ordinary skill in the art of the present disclosure may flexibly determine the material of the light transmission member 120 depending on actual needs.

Structurally, the main housing 110 has a first surface 112 while the shield 140 has a second surface 141 facing the first surface 112. In addition, the profile along the first surface 112 fits the profile along the second surface 141 in shape. Therefore, the first surface 112 of the main housing 110 and the second surface 141 of the shield 140 can have a good contact and there exists no seam in between. As a result, when rainwater falls on the top of the main housing 110, it cannot flow through between the main housing 110 and the shield 140. Thus, the rainwater falling on the top of the main housing 110 cannot reach the front face 111 of the main housing 110 and block the view of the scene the monitoring system 200 is capturing.

To further prevent any rainwater from flowing through between the main housing 110 and the shield 140, a sealing piece 150 can be disposed between the main housing 110 and the shield 140. As shown in FIG. 1, in this embodiment, the sealing piece 150 is disposed along the profile of the first surface 112 and the profile of the second surface 141.

Furthermore, the sealing piece 150 can be made of waterproof sealing material like rubber. However, this choice of material does not limit the present disclosure.

As shown in FIG. 1, the housing assembly 100 further includes a guiding groove 160. The guiding groove 160 is disposed on at least part of an edge of a surface 144 of the shield 140 opposite to the main housing 110. In case rainwater falls on the surface 144 of the shield 140 and flow along the shield 140 to a direction the shield 140 is extended, the rainwater will be collected and guided by the guiding groove 160 to the side edges of the shield 140. Therefore, no rainwater will drop in front of the light transmission member 120 and thus the quality of the view captured by the monitoring system 200 will not be affected.

As mentioned above, the profile along the first surface 112 fits the profile along the second surface 141 in shape. This leads to an advantage that the sliding of the shield 140 relative to the main housing 110 can be guided by this fitness of profiles. Moreover, in order to enhance the effect of guiding, as shown in FIG. 1, the main housing 110 includes a first guiding structure 113 disposed at an edge of the first surface 112, and the shield 140 includes a second guiding structure 142 disposed at an edge of the second surface 141. The first guiding structure 113 is slidably engaged to the second guiding structure 142 such that sliding of the shield 140 relative to the main housing 110 is well guided.

In order to secure the position of the shield 140 relative to the main housing 110 after the shield 140 has slid to an appropriate position, the main housing 110 includes a locking member 114. The locking member 114 is configured for locking the shield 140 to the main housing 110. In this way, the position of the shield 140 relative to the main housing 110 can be selectively fixed.

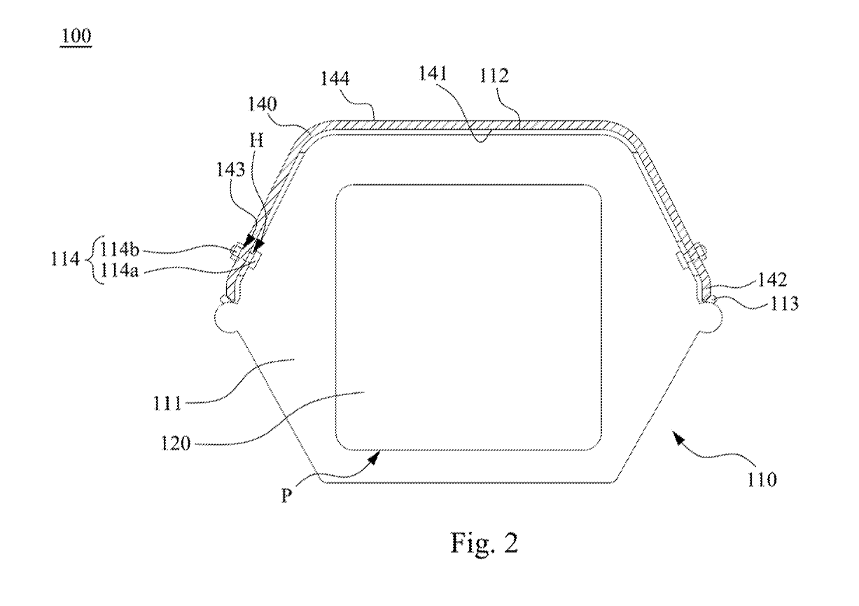

Please refer to FIG. 2. FIG. 2 is a sectional view of the housing assembly 100 of FIG. 1 along the section line A-A. In this embodiment, as shown in FIGS. 1-2, the main housing 110 has a through hole H, while the shield 140 has a slot 143 communicated with the through hole H. The locking member 114 includes a bolt 114a and a nut 114b. The bolt 114a passes through the slot 143 and the through hole H and is fastened into the nut 114b. However, this arrangement does not limit the present disclosure. If either the housing assembly 100 or the shield 140 is thick enough to be threaded, the nut 114b can be omitted.

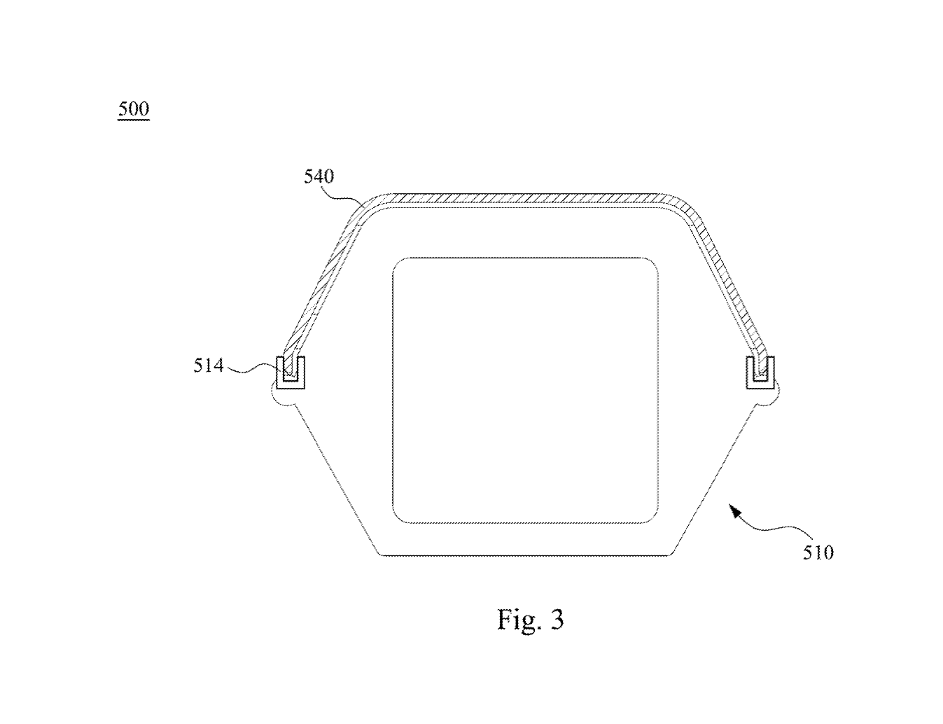

FIG. 3 is a sectional view of a housing assembly 500 according to another embodiment of the present disclosure along the section line A-A of FIG. 1. In this embodiment, the locking member 514 is a clamp. In addition, no through hole is required on the main housing 510, while no slot is required on the shield 540. After the shield 540 has slid to an appropriate position, the clamp will clamp and fix the relative position of the shield 540 and the main housing 510. It is noted that the mode to fixing the shield 540 to the main housing 510 as cited herein is only illustrative and is not to limit the claimed scope. A person having ordinary skill in the art of the present disclosure may flexibly design the mode to fix the shield 540 to the main housing 510 depending on actual needs.

In summary, when compared with the prior art, the embodiments of the present disclosure mentioned above have at least the following advantages:

(1) In the embodiments of the present disclosure, a shield is slidably connected to the main housing and capable of sliding to extend outwards from the front face. That means the extension of the shield from the front face can be adjusted according to different outdoor conditions. Thus, the shield can effectively prevent any unwanted light from entering into the monitoring system and unwanted substances like rainwater and dust from sticking on the light transmission member and blocking he view of the scene the monitoring system is capturing.

(2) In the embodiments of the present disclosure, a profile along the first surface of the main housing fits in shape with a profile along the second surface of the shield Therefore, there is no seam between the main housing and the shield. When rainwater falls on the top of the main housing, it cannot flow through between the main housing and the shield. Thus, the rainwater falling on the top of the main housing cannot reach the front face of the main housing and block the view of the scene the monitoring system is capturing.

(3) Since the position of the shield relative to the main housing is fixed simply by a locking member locking the shield to the main housing, the operation is simple and easy especially in outdoor conditions.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A housing assembly for a monitoring system, the housing assembly comprising:
a main housing having a front face, the main housing having an opening located on the front face, wherein the monitoring system is located in the main housing;
a light transmission member assembled with the opening, wherein the monitoring system monitors via the light transmission member;
an adjustable arm connected to the main housing and a fixed object outside the main housing for adjusting an orientation of the main housing relative to the fixed object; and
a shield slidably connected to the main housing and capable of sliding to extend outwards from the front face.

2. The housing assembly of claim 1, wherein the light transmission member transparent.

3. The housing assembly of claim 1, wherein the main housing has a first surface, the shield has a second surface facing the first surface, a profile along the first surface fits a profile along the second surface in shape.

4. The housing assembly of claim 3, wherein the main housing comprises a first guiding structure disposed at an edge of the first surface, the shield comprises a second g ding structure disposed at an edge of the second surface, the first guiding structure is slidably engaged to the second guiding structure such that sliding of the shield relative to the main housing is guided.

5. The housing assembly of claim 1, wherein the shield is located on top of the main housing relative to a horizontal reference plane.

6. The housing assembly of claim 1, further comprising:
a sealing piece disposed between the main housing and the shield.

7. The housing assembly of claim 6, wherein the sealing piece is made of waterproof sealing material.

8. The housing assembly of claim 1, wherein the main housing comprises:
a locking member configured for locking the shield to the main housing to selectively fix the position of the shield relative to the main housing.

9. The housing assembly of claim 8, wherein the main housing has a through hole, the shield has a slot communicated with the through hole, the locking member comprises a bolt and a nut, the bolt passes through the slot and the through hole and is fastened into the nut.

10. The housing assembly of claim 8, wherein the locking member is a clamp.

11. The housing assembly of claim 1, further comprising:
a guiding groove disposed on at least part of an edge of a surface of the shield opposite to the main housing.
